(19) United States
(12) Patent Application Publication
(10) Pub. No.: US 2005/0221645 A1
(43) Pub. Date: Oct. 6, 2005

(54) Anisotropically conductive block and its manufacturing method

(76) Inventor: Miki Hasegawa, Aichi (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/508,048

(22) PCT Filed: Mar. 20, 2003
(86) PCT No.: PCT/JP03/03464

§ 371 Date: Apr. 28, 2005

(30) Foreign Application Priority Data
Mar. 20, 2002 (JP) 2002-79750

(51) Int. Cl. H01R 4/58

(52) U.S. Cl. 439/86

(57) ABSTRACT

The present invention relates to an anisotropically conductive block, which establishes electrical continuity between electric terminals when it is interposed between the terminals, and its manufacturing method and is aimed at providing an anisotropically conductive block capable of offering conductivity independently in multi-directions. The anisotropically conductive block (10) is configured by arranging conductive paths (e.g. (24) and (44)) while dislocating the paths in Z direction, wherein the conductive paths are non-conductive in a certain direction (Z direction) and have conductivity in a plurality of directions, in directions substantially in parallel with a plane (X-Y plane) perpendicular to Z direction.

### FIELD OF THE INVENTION

The present invention relates to an anisotropically conductive block, which establishes electrical continuity between electric terminals when it is interposed between the terminals, and its manufacturing method.

### RELATED ART

In recent years there has been a practice to interpose an anisotropically-conductive elastomeric sheet between an electronic component and a circuit board thereby to establish electrical continuity between them. Herein, the anisotropically conductive sheet means a sheet capable of having conductivity only in certain directions (typically in one direction). Anisotropically conductive sheets like this include ones exhibiting conductivity only in the direction of the sickness of the anisotropically conductive sheet, and ones exhibiting conductivity only in the direction of the thickness thereof when subjected to a pressure in the direction of its thickness. The latter has a conductive portion with pressure-induced conductivity and enables the achievement of compact electrical connection without means such as soldering or mechanical engagement. Also, it has a feature such that elasticity of the sheet is utilized to absorb a mechanical shock or strain and enables a soft connection. Such feature is utilized, for example, in the fields of cellular phones, electronic calculators, electronic digital clocks and watches, digital cameras, computers, etc. and the sheets are widely used as connectors to establish mutual electrical connections among circuit units, e.g. a printed circuit board, a leadless chip carrier, and a liquid crystal panel.

Further, concerning electrical inspections of circuit units such as printed circuit boards and semiconductor integrated circuits, in order to establish electrical connection between a n inspected electrode formed on at least one face of a circuit unit to be inspected and an inspecting electrode formed on a surface of an inspecting circuit board, there has been a practice to interpose an anisotropically-conductive elastomeric sheet between the inspected electrode area of the circuit unit and the inspecting electrode area of the inspecting circuit board.

However, in regard to such anisotropically conductive sheet or anisotropically conductive elastomer, electrical continuity is merely established between surfaces facing each other substantially in parallel, and there is established no electrical continuity between substantially non-parallel surfaces such as surfaces crossing each other at a substantially right angle. In addition, when there is established electrical continuity between a pair of surfaces facing each other substantially in parallel, it is impossible to concurrently and independently establish electrical continuity between another pair of surfaces facing each other substantially in parallel.

The present invention provides an anisotropically conductive block, which was devised under the circumstance described above, and which makes possible to establish electrical continuity even between surfaces other than surfaces facing each other substantially in parallel and to establish electrical continuity even between paired surfaces of plural pairs independently for each pair.

### DISCLOSURE OF THE INVENTION

The present invention provides: an anisotropically conductive block having a non-conductivity in a certain direction (Z direction) and having a conductivity substantially in parallel with a plane perpendicular to the Z direction (X-Y plane) at a predetermined angle with respect to a surface of the block; an anisotropically conductive block having conductive properties in a plurality of directions substantially in parallel with a plane (X-Y plane) perpendicular to the Z direction; and their manufacturing methods.

More specifically, the present invention provides the following.

(1) An anisotropically conductive block having predetermined three dimensions, wherein the conductivity in Direction 1 (“1-conductivity”) differs from the conductivity (“predetermined conductivity”) in a predetermined direction contained in a plane substantially perpendicular to said Direction 1.

Further, an anisotropically conductive block having predetermined three dimensions, comprising: a plurality of electroconductive paths inside said anisotropically conductive block; a first conductive path being composed of at least one of said plurality of electroconductive paths between a first electrical contact point in electrical contact with a first region in an outer surface of said anisotropically conductive block and a second electrical contact point in contact with a second region of said outer surface; and a second conductive path composed of at least one of said plurality of electroconductive paths between a third electrical contact point in electrical contact with a third region of the outer surface of said anisotropically conductive block and a fourth electrical contact point in contact with a fourth region of said outer surface, wherein said first conductive path and said second conductive path are non-conductive with each other, and wherein a first direction of conductivity produced by linearly connecting said first electrical contact point with said second electrical contact point crosses a second direction of conductivity produced by linearly connecting said third electrical contact point with fourth electrical contact point at a predetermined angle.

(2) An anisotropically conductive block having predetermined dimensions in X-axis, Y-axis, and Z-axis directions, each orthogonal to the others in three dimensions, the block having a conductive property evaluated between a first contact point in contact with a first region of an outer surface of the anisotropically conductive block and a second contact point in contact with a second region thereof, wherein the conductive property is non-conductive when a line-connecting direction produced by connecting said first contact point with said second contact point is substantially in parallel with said Z-axis direction, and is conductive when said line-connecting direction is substantially in parallel with each of a predetermined first direction and a predetermined second direction, which are substantially in parallel with a plane defined by said X-axis and Y-axis, wherein said first direction and second direction intersects in plan view as seen from said Z-axis, and wherein said first direction and said second direction interfere with each other in conductivity.

(3) An anisotropically conductive block being non-conductive in a first direction, comprising electroconductive paths therein independent in one or more different directions substantially perpendicular to said first direction, wherein said electroconductive paths become usable by press-contacting with an outer surface of the anisotropically conductive block.

(4) An anisotropically conductive block comprising electroconductive paths independent in a plurality of different directions, wherein said plurality of different directions are substantially in parallel with one plane, wherein in plan view if projected onto the one plane, at least one pair of directions selected from said plurality of different directions intersect in the one plane in plan view, wherein in lateral view if projected onto a plane substantially perpendicular to the one plane, none of said plurality of different directions intersect, and wherein said electroconductive paths become usable by press-contacting with the anisotropically conductive block.

(5) The anisotropically conductive block according to any one from (1) to (4), wherein the block is composed of: a conductive elastomer; and a non-conductive elastomer.

(6) An anisotropically conductive block including a composite sheet comprising: a non-conductive sheet of non-conductive material, having a substantially-constant thickness, and having an upside surface (front surface) and a downside surface (back surface) respectively on up and down sides across the thickness; and a sheet having a substantially-constant thickness, having an upside surface (front surface) and a downside surface (back surface) respectively on up and down sides across the thickness, and having an electroconductive path extending from one end portion of the sheet to the other in a first direction substantially in parallel with the upside surface (front surface) or downside surface (back surface) of the sheet, the sheet with electroconductive path being superposed on the upside surface (front surface) of the non-conductive sheet so that the downside surface thereof is in contact with the upside surface (front surface) of said non-conductive sheet.

(7) The anisotropically conductive block according to (6), wherein said non-conductive sheet comprises a non-conductive elastomer.

(8) The anisotropically conductive block according to any one of (1) and (2)-(7), wherein said electroconductive path comprises an electroconductive elastomer.

(9) The anisotropically conductive block according to (8), wherein the electroconductive elastomer constituting the electroconductive path comprises a member of superior conductivity being in contact electrically along the path.

(10) The anisotropically conductive block according to (9), wherein said member of superior conductivity comprises an adhesive layer and a conductive layer.

(11) The anisotropically conductive block according to (10), wherein said adhesive layer comprises indium tin oxide.

(12) The anisotropically conductive block according to (10) or (11), wherein said conductive layer comprises: a layer of good conductive metal; and a layer of flexible metal.

(13) The anisotropically conductive block according to any one of (1), and (3)-(12), wherein said electroconductive path is surrounded by non-conductive members along the path, and runs across the anisotropically conductive block, and wherein an end portion of said electroconductive path appears in an outer surface of the anisotropically conductive block, and the end portion protrudes in comparison with non-conductive members around the appearing end portion.

(14) A method of manufacturing an anisotropically conductive block, comprising: an AB sheet stacking step of alternately stacking conductive sheets (A) of conductive material having a predetermined thickness and predetermined faces on up and down sides across the thickness and non-conductive sheets (B) of non-conductive material having a predetermined thickness and predetermined faces on up and down sides across the thickness thereby to produce an AB sheet laminate; a cutting step of cutting said AB sheet laminate produced in the AB sheet stacking step into a zebra-like sheet in a predetermined thickness; and a zebra-D sheet stacking step of alternately stacking zebra-like sheets produced in the cutting step and non-conductive sheets (D) of non-conductive material.

(15) A method of manufacturing an anisotropically conductive block comprising: a conductive material depositing step of depositing a good conductive member, which is a member of superior conductivity, on a surface of each of conductive sheets (A) of conductive material having a predetermined thickness and predetermined faces on up and down sides across the thickness thereby to produce conductive sheets (A) with good conductive member; an AB sheet stacking step of alternately stacking said conductive sheets (A) with good conductive member produced in the conductive material depositing step and non-conductive sheets (B) of non-conductive material having a predetermined thickness and predetermined faces on up and down sides across the thickness thereby to produce an AB sheet laminate; a cutting step of cutting said AB sheet laminate produced in the AB sheet stacking step into a zebra-like sheet with a predetermined thickness; and a zebra-D sheet stacking step of alternately stacking said zebra-like sheets produced in the cutting step and non-conductive sheets (D) of non-conductive material.

In the present invention, the anisotropically conductive block having predetermined three dimensions may be characterized in that the conductivity in Direction 1 (hereinafter referred to as “1-conductivity”) differs from the conductivity (hereinafter referred to as “predetermined conductivity”) in a predetermined direction included in a plane substantially perpendicular to said Direction 1. Here, the term 1-conductivity may mean the conductivity of the anisotropically conductive block in the predetermined Direction 1 or may mean a conductivity (or resistance) obtained when the conductivity (or resistance) of the anisotropically conductive block is measured in the Direction 1. Further, the phrase, substantially perpendicular plane, may mean a plane substantially perpendicular to Direction 1, and may include any planes that can overlap one plane when displaced in parallel. In addition, the phrase, included in a plane, may mean to be included in the plane if displaced in parallel, and it may mean, for example, that all of straight lines which can overlap the above-described predetermined direction can be included in the above-described plane when displaced in parallel. The phrase, predetermined conductivity, may mean the conductivity of the anisotropically conductive block in a predetermined direction, or may mean the conductivity (or resistance) obtained when the conductivity (or resistance) of the anisotropically conductive block is measured in a predetermined direction. The phrase, the conductivity in Direction 1 differs from the predetermined conductivity, may imply that the case where one conductivity is non-conductive and the other is conductive, and may include the case where one conductivity is lower than the other one.

The foregoing phrase, having predetermined dimensions in X-axis, Y-axis, and Z-axis directions, in (2) is included in the above-described phrase, having three dimensions, and it may mean having a characteristic form particularly in a rectangular coordinate system. Here, because there is no conductivity in Z-axis direction and the direction in question is substantially in parallel with a plane defined by X- and Y-axes that are orthogonal to the Z-axis, there may be conductivity with the ends fixed in one or more directions substantially perpendicular to Z-axis. The phrase, conductivity with the ends, may imply that the conductivity is secured continuously between the two ends, provided that the conductivity is not concurrently developed in all directions in a plane substantially in parallel with the plane defined by X- and Y-axes, but developed only in a predetermined direction. For example, the situation where the conductivity runs like a path is possible, where the path may have a certain width not extending infinitely and a one end and the other end in the direction of the path (these two ends make both ends). The phrase, both ends of the conductivity are exposed in surfaces the anisotropically conductive block, may imply the condition where continuous conductivity may be included inside the conductive block, but both the ends thereof are exposed in surfaces of the conductive block and therefore the conductivity can be utilized from outside the block. Therefore, the phrase, be exposed, may represent to be electrically exposed, which doesn't necessarily represent to be visible actually and the phrase just represents to be electrically conductive. Such exposed portions may be used as electrical contact points. More specifically, when one of both the ends of the conductivity is used as a first electrical contact point and the other end is used as a second electrical contact point, electrical continuity can be established between the first and second electrical contact points. Further, the first and second electrical contact points can be replaced with each other to be made second and first electrical contact points, of course.

The direction defined by a surface of the conductive block and a plane defined by X-axis and Y-axis (hereinafter referred to as “X-Y plane”) may be the direction of the intersection line of the surface of the conductive block and X-Y plane. The predetermined angle is 90° or less. This is because plus and minus directions are not distinguished here and therefore the angle doesn't exceed 90°. For example, if the predetermined angle is 45°, it is possible to secure conductivity not only between opposed faces in the block but also between adjacent faces as in the case of the connection between terminals located at a corner. Particularly, when the angle is sufficiently smaller than 90°, it is possible to provide conductivity between terminals located in two faces which would intersect at least when extended. The predetermined angle may be an angle formed by one end of the ends with respect to the surface where the one end is exposed. Concretely, it is preferably smaller than approximately 80°, and more preferably 70° or smaller.

Further, in the present invention, the block may be non-conductive in Direction 1, and may have conductivity in a plurality of directions in a plane perpendicular to Direction 1. “Direction 1” may mean a certain direction (e.g. Z direction). In addition, “non-conductive” may mean substantially avoiding electricity flowing, and also mean having a sufficiently large electrical resistance. The phrase, substantially perpendicular plane, may mean a plane in substantially perpendicular (or right-angled) relation with respect to Direction 1, and may include a plurality of planes in parallel with such plane. Further, the phrase, in a plane, may imply that the subject in question is included in the plane. The phrase, a plurality of directions, may mean directions included in the plane, and it may imply that when a certain direction has been already selected, there are at least one direction which is not in parallel with the selected direction in the plane. In other words, it may imply that these directions (or straight lines overlapping with the respective directions) cross each other in the plane. Also, the phrase, have conductivity, may imply that it is possible to substantially flow electricity through the subject in question and the subject has a sufficiently small electrical resistance. In addition, it is desirable that when the block have conductivity, the resistance between terminals to be connected is typically 100 Ω or smaller (preferably 10 Ω or smaller, and more preferably 1 Ω or smaller).

Also, the present invention may be characterized by being non-conductive in Direction 1 and having electroconductive paths (also hereinafter referred to as “conductive paths” or “conductive paths”) independent in a plurality of different directions in a plane substantially perpendicular to Direction 1. The word, independent, may imply: the paths are out of electrical contact with each other; no electricity can flow therebetween; and there is a sufficiently high electrical resistance therebetween. Further, the phrase, independent conductive paths, may imply: the conductive paths are out of electrical contact with each other as described above; no electricity can mutually flow between the conductive paths; and there is a sufficiently high electrical resistance between conductive paths. However, it is possible to flow electricity inside each of the conductive paths. It may be implied that the above-described conductive paths are not paths which allow electricity to flow in all directions in a plane where the conductive paths are included, but paths which allow electricity to flow through the paths in the plane where the conductive paths are included.

Further, the present invention may be characterized by an anisotropically conductive block having electroconductive paths (also hereinafter referred to as “conductive paths”) independent in a plurality of different directions, wherein the plurality of different directions are substantially in parallel with a plane. The phrase, the plurality of different directions are substantially in parallel with a plane, may imply the case where there are a plurality of different directions overlapping the others as described above, and the plurality of directions are substantially included in a certain plane. Also, the sentence may imply that all of straight lines representing a plurality of different directions are included in a certain plane, or all of them are in parallel with the plane.

Also the present invention may include a dual sheet, i.e. a composite sheet including: a non-conductive sheet of a non-conductive material, having a substantially-constant thickness, and having predetermined faces respectively on up and down sides of the thickness; and a first conductive sheet, i.e. a sheet having a substantially-constant thickness, predetermined faces respectively on up and down sides of the thickness, and an electroconductive path (also hereinafter referred to as “conductive path”) in Direction 1 substantially in parallel with the upside surface or downside surface of the sheet, superposed on the upside surface of the non-conductive sheet so that the downside surface of the first conductive sheet is in contact with the upside surface of said non-conductive sheet. The phrase, having a substantially-constant thickness, may imply that the sheet has a predetermined thickness that is substantially constant. Further, the phrase, having predetermined faces on up (front) and down (back) sides of the thickness, may imply that the sheet having a substantially-constant thickness has an upside surface (front surface) and a downside surface (back surface) with its thickness placed in the center of the surfaces. Here, the non-conductive sheet may mean a sheet that is not conductive and has no conductivity, or may mean a sheet having a sufficiently high electrical resistance. The phrase, substantially in parallel with the upside surface or downside surface of the sheet, may imply that if the direction in question is displaced in parallel, the direction would be substantially included in the sheet face surely and also imply that the straight line representing the direction never intersects the sheet face substantially. Here, the phrase, having an electroconductive path in the first direction, may imply that there is a path which allows electricity to flow in a certain direction, which doesn't imply that there is a path which allows electricity to flow in all the directions in the sheet face. The direction of the path is not necessarily in a straight line and it may be in a curve. For example, it may include a remarkably serpentine portion like a hairpin curve or a zigzag portion.

Now, the phrase, superposed so that the downside surface (back surface) of the first conductive sheet is in contact with the upside surface (front surface) of said non-conductive sheet, may imply the situation where the first conductive sheet is superposed on the surface of the non-conductive sheet, and the phrase, downside surface and upside surface are in contact, may include they directly contact the other, and may include they indirectly contact the other with something else interposed therebetween. Therefore, it may include the case where a third sheet, a coupling agent, or the like is sandwiched therebetween and its thickness is larger than the sum of thicknesses of both the sheets.

Also, the present invention may be characterized in that said non-conductive sheet is made from a non-conductive elastomer (also hereinafter referred to as “non-conductive elastomer”). The non-conductive elastomer may mean an elastomer having no conductivity, o r may mean an elastomer having a sufficiently high electrical resistance. More concretely, what can be used as such non-conductive elastomer is: caoutchouc; polyisoprene rubber; butadiene copolymers and conjugated diene-based rubbers of butadiene-styrene, butadiene-acrylonitrile, butadiene-isobutylene, etc., and those subjected to hydrogenation; styrene-butadiene-diene block copolymer rubber; block copolymer rubbers of styrene-isoprene block copolymer, etc. and those subjected to hydrogenation; chloroprene polymer; vinyl chloride-vinyl acetate copolymer; urethane rubber; polyester-based rubber; epichlorohydrin rubber; ethylene-propylene copolymer rubber; ethylene-propylene-diene copolymer rubber; soft liquid epoxy rubber; silicone rubber; fluororubber; or the like. Of these materials, what is preferably used is silicone rubber superior in heat resistance, brittle resistance at low temperature, chemical resistance, weather resistance, electrical insulating property, and safety. Such non-conductive elastomer is typically non-conductive because it has a large volume resistance (e.g. 1 MΩ*cm or larger at 100 V).

Further, the present invention may be characterized in that said conductive path is made from an electroconductive elastomer (also hereinafter referred to as “conductive elastomer”). The conductive elastomer may mean an elastomer having a high conductivity, or may mean an elastomer having a sufficiently low electrical resistance. Typically, an example of such conductive elastomer is an elastomer in which an electroconductive material is mixed so that its specific volume resistance is lowered (e.g. 1 Ω*cm or smaller). More concretely, what can be used as such elastomer is: caoutchouc; polyisoprene rubber; butadiene copolymers and conjugated diene-based rubbers of butadiene-styrene, butadiene-acrylonitrile, butadiene-isobutylene, etc., and those subjected to hydrogenation; styrene-butadiene-diene block copolymer rubber; block copolymer rubbers of styrene-isoprene block copolymer, etc. and those subjected to hydrogenation; chloroprene polymer; vinyl chloride-vinyl acetate copolymer; urethane rubber; polyester-based rubber; epichlorohydrin rubber; ethylene-propylene copolymer rubber; ethylene-propylene-diene copolymer rubber; soft liquid epoxy rubber; silicone rubber; fluororubber; or the like. Of these materials, what is preferably used is silicone rubber superior in heat resistance, brittle resistance at low temperature, chemical resistance, weather resistance, electrical insulating property, and safety. A conductive elastomer can be formed by blending the following conductive substance into such elastomer: a powdered metal (for which a substitutable form is a flake, a fragment, a foil, or the like) of gold, silver, copper, nickel, tungsten, platinum, palladium, other pure metals, SUS, phosphor bronze, beryllium copper, or the like; or nonmetallic powder (for which a substitutable form is a flake, a fragment, a foil, or the like) of carbon, or the like. Incidentally, the carbon may include carbon nanotube, fullerene, etc.

Further, the present invention may be characterized in that a member superior in conductivity (also hereinafter referred to as “well-conductive member”) is in electrical contact with said conductive elastomer. Here, the well-conductive member may be a member made from a material with a good conductivity. The material with a good conductivity may be, for example, a metallic material such as copper, or silver, or a material other than metals such as graphite or carbon (which may include carbon nanotube, fullerene, etc.), or may be a material that has a volume resistance lower than that of a conductive elastomer and is superior in conductivity. In addition, the well-conductive member may be a metal layer of a metallic material. The case of a metal layer may include the case where the entire metal layer is made from a kind of metal. Further, the phrase, in electrical contact, may imply that electricity can flow between the conductive elastomer and the well-conductive member. Also, it may imply that the well-conductive member is electrically connected with the conductive elastomer. The well-conductive member has a higher conductivity than that of the conductive member and as such, when electricity flows through the members in parallel (side by side), the degree of electrical conduction of the well-conductive member becomes dominant totally. As a result, the resistance of the conductive path becomes lower in the case where the well-conductive member is deposited to the path.

Also, the present invention may be characterized in that the well-conductive member is composed of an adhesive layer and a conductive layer. Here, the adhesive layer may be a layer intended for the improvement of adhesion with the conductive elastomer when the metal layer is in contact with the conductive elastomer. Typically, the conductive layer of the metal layer is vastly different in physical and chemical properties from the conductive member and as such, the adhesive layer may have functions for enhancing the adhesion between the conductive layer and the conductive member, such as having an intermediate property with respect to the properties of the conductive layer and conductive member, and gluing the conductive layer and the conductive member. Therefore, the present invention may be characterized in that said adhesive layer is arranged on the side of the conductive elastomer brought into contact with the metal layer having the adhesive layer as a constituent element. For example, the adhesive layer may make possible to reduce the occurrence of strains owing to the difference in coefficient of thermal expansion, etc. and absorb such strains. The conductive layer may mean a layer superior in conductivity and may be made from a metal superior in conductivity or the like. The present invention may be characterized in that such adhesive layer is made from a metal oxide or a metal. Examples of such metal oxide include indium oxide, tin oxide, and titanium oxide, a mixture thereof, and a chemical compound thereof; examples of such metal include chromium. For example, the present invention may be characterized in that the adhesive layer is made from indium tin oxide, or indium oxide-tin oxide. “Indium tin oxide (or indium oxide-tin oxide)” is referred to as ITO in an abbreviation, and is a ceramic material having a high electrical conductive property. The conductive layer may be made from a metal with a good conductivity. This is because in the case of using a metal having an electrical conductive property higher than that of the conductive member, when electricity flows in parallel (side by side), the electrical resistance of the metal becomes dominant in the total electrical resistance.

Also, the present invention may be characterized in that said conductive layer is composed of: a layer of a metal with a good conductivity (also hereinafter referred to as “well-conductive layer”); and a layer of a flexible metal (also hereinafter referred to as “flexible layer.” The flexible layer may be a layer of a metal capable of flexibly deforming itself in response to external deformation of a substrate, etc. and less prone to electrical disconnections owing to cracking or fracture. The layer of a metal with a good electrical conductivity may be a layer made from a metal having a higher degree of electrical conduction than that of the flexible metal in the environment where it is used. Preferably, the metal with a good electrical conductivity may be twice or more times as large as the flexible metal in the degree of electrical conduction, and more preferably may be five or more times. The reason why metallic layers are combined like this lies in: it was found that the requirements for flexibility and high electrical conductivity are not necessarily satisfied by one kind of metal.

While examples of such flexible metal include pure metals, such as indium and tin, and alloys, such as an alloy of indium and tin, “Rikagaku-jiten” (Iwanami Shoten, Publishers) states: Indium is flexible, whereas it has a specific resistance of 8.4×10⁻⁶ Ωcm; Tin has a specific resistance of 11.4×10⁻⁶ Ωcm; and Lead has a specific resistance of 20.8×10⁻⁶ Ωcm. On the other hand, while cited as such a metal with a high electrical conductivity are pure metals such as copper, silver, and gold, and an alloy of those, likewise “Rikagaku-jiten” (Iwanami Shoten, Publishers) states: Copper has a specific resistance of 1.72×10⁻⁶ Ωcm; Silver has a specific resistance of 1.62×10⁻⁶ Ωcm; and Gold has a specific resistance of 2.2×10⁻⁶ Ωcm. Therefore, it is clear that specific resistances of the examples of the flexible metal are twice or more times as large as those of the examples of the metal with a high electrical conductivity.

Here, the layer of a metal with a good electrical conductivity, in electrical contact with the layer of a flexible metal may imply that even when the layer of a metal with a good electrical conductivity is fractured owing to handling, etc. and thus electricity cannot flow across the fractured region, electricity can flow through the layer of a flexible metal in contact therewith and therefore it is possible to cause electricity to flow over the fractured region. The flexible metal has a low electrical conductivity as described above and as such, after having passed over the fractured region once, the electricity may be sent to a portion of the layer of a metal with a good electrical conductivity on the opposite side of the fractured region. Since such structure is adopted, the layer of a flexible metal can function as a redundant system of the path of electricity. It can be considered that when some diffusion arises between the layers, the mutual adhesion between the layers is improved and thus the functions of the above multilayer can be improved. However, it is considered that when the diffusion has excessively progressed to bring the layers into a completely mixed condition, the multilayer effect is lessened.

In addition, the present invention may be characterized by an anisotropically conductive block wherein said conductive path is surrounded by non-conductive members and runs across the block, end portions of said conductive path are protruding in comparison with the non-conductive members around the end portions. Further, the phrase, the conductive path is surrounded by non-conductive members, may be considered to imply that the conductive path is electrically insulated from its circumference by the non-conductive member, and to imply that it is difficult to cause electricity to flow in directions other than the path direction of the conductive path. Further, the phrase, the conductive path runs across the block, may imply that ends of the conductive path outcrop in one side surface of the anisotropically conductive block and another side surface thereof; the conductive path may have the function for electrically connecting one side surface with the other side surface. In addition, the phrase, protruding, may imply the situation where the conductive path projects in comparison to its surrounding members, and also imply a form such that when a face is pressed substantially in parallel with and against the side surface where the conductive path outcrop from a distance, the end of the conductive path contacts the face earlier than the surrounding members.

The present invention may be characterized by including: an A and B sheets' stacking step of: alternately stacking conductive sheets (A) of a conductive material having a predetermined thickness and predetermined faces on up and down sides of the thickness and non-conductive sheets (B) of a non-conductive material having a predetermined thickness and predetermined faces on up and down sides of the thickness thereby to produce an A-and-B-sheets-laminated structure; a cutting step of cutting said A-and-B-sheets-laminated structure produced in the A and B sheets' stacking step into zebra sheets with a predetermined thickness; and a zebra and D sheets' stacking step of alternately stacking said zebra sheets produced in the cutting step and non-conductive sheets (D) of a non-conductive material. The conductive sheets (A) are flexible sheets, each having a certain thickness and having an upside surface (front surface) and a downside surface (back surface), and it may have a conductivity. Further, the non-conductive sheets (B) are flexible sheets, each having a certain thickness and having an upside surface (front surface) and a downside surface (back surface), and it may have a non-conductivity. These sheets may be of a type, or may be of different types. For example, the conductive sheets (A) may be of the same material, but may be varied in thickness. This applies also to the case of the non-conductive sheets (B).

The phrase, alternately stacking, may imply alternately stacking said conductive sheets (A) and said non-conductive sheets (B) in an arbitrary order, which doesn't prevent further sandwiching a third (and/or a fourth) sheet, a film, other members, etc. between said conductive sheet (A) and said non-conductive sheet (B). Further, in each of the sheet stacking steps a coupling agent may be put between the sheets to bond therebetween. Such coupling agent may be a binder for bonding the members and may contain a commercially available, ordinary adhesive. Concretely, such coupling agent may be a silane-based, aluminum-based, or titanate-based coupling agent, and a silane coupling agent is used well.

The A-and-B-sheets-laminated structure (C) produced by these stacking may be subjected to a heating treatment, etc. in order to enhance the affinity between sheets, and expedite curing of the sheet members themselves, or for the other purposes.

Said A-and-B-sheets-laminated structure (C), may be subjected to cutting by a blade of a super steel cutter, a ceramic cutter, or the like, and abrasive cutting-off by a whetstone such as a fine cutter, sawing by a sawing machine such as saw, or cutting by other cutting machines or cutting tools (which may include non-contact type cutting machines such as a laser cutting machine). Moreover, in order to prevent overheating, and to obtain a clean cut area or for other purposes in the cutting process, the laminated structure may be cut using a cutting fluid such as a cutting oil, or it may be cut by a dry process. While the subject to be cut may be cut while being rotated alone or together with a cutting machine or a cutting tool, it is needless to say that various conditions for cutting are appropriately selected depending on said A-and-B-sheets-laminated structure (C). The phrase, cutting with a predetermined thickness, may imply cutting the laminated structure so that sheet members having a predetermined thickness can be produced. The predetermined thickness is not necessarily uniform, and may be changed depending on the place of the sheet member.

Further, the present invention may include a conductive-material-depositing step of depositing a well-conductive member on a surface of each of conductive sheets (A) thereby to produce well-conductive-member-equipped conductive sheets (A), and the resultant well-conductive-member-equipped conductive sheets (A) may be used instead of conductive sheet (A) in the above A and B sheets' stacking step. The well-conductive member may include a metal layer of a metal and may be deposited on one face of each conductive sheet (A) or both faces thereof. Such well-conductive member can be deposited by any one or a combination of gas phase, liquid phase, solid phase methods, and particularly gas phase methods are preferable. Gas phase methods include PVDs such as sputtering, vapor deposition, etc. and CVDs. When the well-conductive member is composed of adhesive layers and conductive layers, the individual layers may be deposited by the same method, or may be by different methods.

This applies also to the step of alternately stacking said zebra sheets and non-conductive sheets (D) in common with the above-described A and B sheets' stacking step.

### BRIEF DESCRIPTION OF THE DRAWINGS

FIG. 1 is a perspective view showing an anisotropically conductive block as one embodiment of the present invention.

FIG. 2 shows conductive directions in the rectangular coordinate system of the anisotropically conductive block.

FIG. 3 is a perspective view showing the details of a member making an electroconductive path.

FIG. 4 is a view showing a cross section taken along A-A in FIG. 1.

FIG. 5 is concerned with a method of manufacturing an anisotropically conductive block of an embodiment of the present invention, and illustrates an A and B sheets' stacking step of stacking conductive sheets (A) and non-conductive sheets (B).

FIG. 6 is concerned with the method of manufacturing an anisotropically conductive block of the embodiment of the present invention, wherein there is illustrated a cutting step of cutting an A-and-B-sheets-laminated structure (C) stacked as illustrated by FIG. 6 into zebra sheets.

FIG. 7 is concerned with the method of manufacturing an anisotropically conductive block of the embodiment of the present invention, wherein there is illustrated a process of stacking the zebra sheets cut as illustrated by FIG. 7 and non-conductive sheets (D) to obtain an anisotropically conductive block.

FIG. 8 is concerned with the method of manufacturing an anisotropically conductive block of the embodiment of the present invention, and shows by process flows the method of cutting an A-and-B-sheets-laminated structure (C) produced by alternately stacking conductive sheets (A) and non-conductive sheets (B) into zebra sheets.

FIG. 9 is concerned with the method of manufacturing an anisotropically conductive block of the embodiment of the present invention, and shows by process flows the method of alternately stacking the zebra sheets, which is obtained as illustrated by FIG. 8, and non-conductive sheets (D) to obtain an anisotropically conductive block.

FIG. 10 is a plan view showing an anisotropically conductive block of a hexagonal prism form of another embodiment of the present invention.

FIG. 11 is a s ketch showing the anisotropically conductive block of a hexagonal prism form of FIG. 10.

FIG. 12 shows a plan view of an anisotropically conductive block of a cylinder form of another embodiment of the present invention.

FIG. 13 is a view of conductive-path directions.

FIG. 14 is a sketch of an anisotropically conductive block of another embodiment of the present invention.

FIG. 15 shows the anisotropically conductive block cut along the cutting-plane lines 1-1 and 2-2 in FIG. 14.

FIG. 16 is a view showing the situation where the anisotropically conductive block of FIG. 15 is pressed against corner connection terminals.

### DESCRIPTION OF THE PREFERRED EMBODIMENT

While the present invention will be more minutely described below with the embodiments and reference to the drawings, concrete materials and values, etc. are only enumerated as preferred examples of the present invention in the embodiments and therefore the present invention is not limited is to the embodiments.

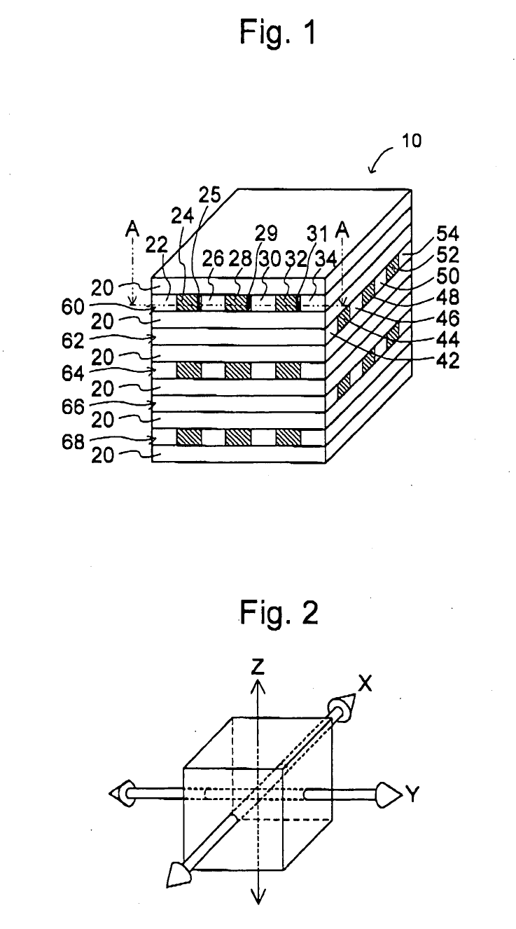

FIG. 1 shows an anisotropically conductive block 10 as an embodiment of the present invention. While the anisotropically conductive block 10 of the embodiment is a rectangular block-shaped body in FIG. 1, a block-shaped body of a shape other than a rectangle may be adapted. The anisotropically conductive block 10 is configured by alternately arranging: sheet members (also hereinafter referred to as “non-conductive sheets”) 20, each composed of a non-conductive member; and striped sheet members (also hereinafter referred to as “zebra sheets”) 60, 62, 64, 66, 68 with conductive and non-conductive members alternately arranged. The sheet members are bonded by a coupling agent. Each zebra sheet 60 comprises: non-conductive members 22, 26, 30, and 34; and conductive members 24, 28, and 32 with respective well-conductive members 25, 29, and 31. The zebra sheet 62 located thereunder also comprises non-conductive members 42, 46, 50, and 54 and conductive members 44, 48, and 52. Also, the zebra sheets 64, 66, and 68 located thereunder each comprise non-conductive and conductive members, which are alternately arranged likewise. In regard to the anisotropically conductive block 10, end portions of the conductive members 24, 28, and 32 showing up in the surfaces thereof can make electrical contact points; one end portions on the near side in the drawing may be made to serve as first electrical contact points and the other end portions on the far side in the drawing may be made to serve as second electrical contact points. Likewise, end portions of the conductive members 44, 48, 52 on the right in the drawing may be made to serve as second electrical contact points and end portions on the left may be made to serve as first electrical contact points. The direction of conductivity formed by straight lines connecting the first and second contacts corresponds to the lengthwise direction of the conductive members 24, 28, 32, etc., for example, and therefore a straight line along the lengths of the conductive members 24, 28, 32, etc. is provided in the direction.

For the anisotropically conductive block of the embodiment, a conductive silicone rubber manufactured by Shin-Etsu Polymer Co., Ltd. is used as the conductive elastomer; a silicone rubber manufactured by Mitsubishi Plastics, Inc., a silicone rubber manufactured by Shin-Etsu Polymer Co., Ltd. or the like is used as the non-conductive elastomer; a silane coupling agent manufactured by Shin-Etsu Polymer Co., Ltd. is used as the coupling agent.

In regard to each zebra sheet in the embodiment, the conductive members outcrop in a side surface of the anisotropically conductive block and its opposite side surface, and the members respectively form independent electroconductive paths (also hereinafter referred to as “conductive paths” or “conductive paths”). Likewise, the non-conductive members outcrop in a side surface of the anisotropically conductive block and its opposite side surface and electrically insulate the conductive paths from each other. Further, the non-conductive sheets, which have the zebra sheet sandwiched therebetween, electrically insulate the conductive paths from each other in an up and down direction. Thus, the conductive paths are surrounded by the non-conductive members, isolated from other conductive paths by the non-conductive members, and electrically insulated from other conductive paths.

The zebra sheets 60, 64, and 68 of the anisotropically conductive block of the embodiment outcrop in a side surface, which can be seen on the near side of the anisotropically conductive block, and the zebra sheets are also outcrop in another side surface across the block, i.e. on its opposite side. Accordingly, conductive paths are connected between the side surface on the near side and the side surface on the opposite side, and there is electrical continuity between the side surfaces of the near and opposite sides, and therefore between the side surfaces is produced a situation such that electricity can flow therebetween. However, because the conductive paths (e.g. 24, 28, and 32) are electrically insulated from each other by the non-conductive members 22, 26, 30, and 34, electricity never flows on the skew (or diagonally across the paths). Therefore, even when two different terminals are provided on the electroconductive paths 24 and 32, a so-called cross-wired condition is not brought about.

Further, the zebra sheets 62 and 66 outcrop in a side surface, which can be seen on the right of the anisotropically conductive block, and also outcrop in a side surface on its opposite side, i.e. on the left. Accordingly, conductive paths are connected between the side surface on the right and the side surface on the left, and there is electrical continuity between the side surfaces of the right and left, and therefore between the side surfaces is produced a situation such that electricity can flow therebetween. However, because the conductive paths (e.g. 44, 48, and 52) are electrically insulated from each other by the non-conductive members 42, 46, 50, and 54, electricity never flows on the skew (or diagonally across the paths). Therefore, even when two different terminals are provided on the conductive paths 44 and 52, a so-called cross-wired condition is not brought about.

FIG. 2 is intended for describing directional properties of the functions of the embodiment shown in FIG. 1. While the block is not conductive or is non-conductive in Z-axis direction, i.e. in up and down direction, the block has conductivities respectively in X-axis and Y-axis directions. As shown in FIG. 2, X-, Y-, and Z-axis directions intersect at one point, and it is difficult to impart independent conductivities to the block for two or more directions. In addition, since the embodiment shown in FIG. 1 is of a structure such that a sheet having conductive paths in X- or Y-axis direction is electrically insulated in Z-axis direction by non-conductive sheets, an anisotropically conductive block, which is non-conductive in Z-axis direction and which has conductivities independently in X- and Y-axis directions, can be obtained.

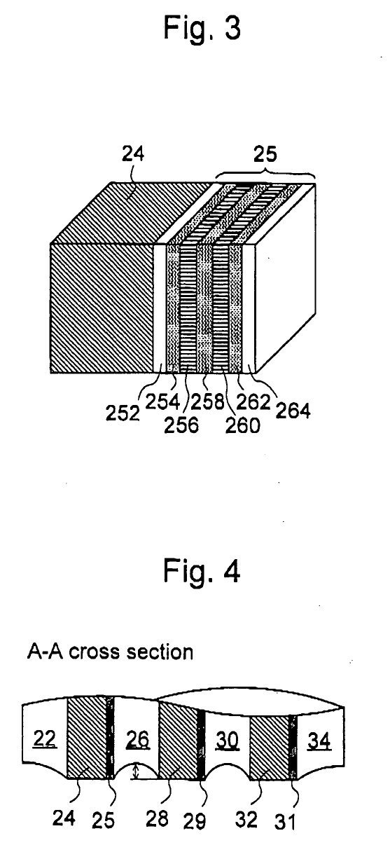

Incidentally, the well-conductive members 25, 29, and 31 are deposited respectively on the conductive paths 24, 28, and 32, details of which will be described with FIG. 3 taking up the conductive path 24. In ascending order of distance from a surface of the base material 24, i.e. electroconductive path, the well-conductive member (i.e. metal layer in the embodiment) 25 comprises: an adhesive layer 252; a layer made from a flexible metal (flexible layer) 254; a layer made from a well-conductive metal (well-conductive layer) 256; a layer made from a flexible metal 258; a layer made from a well-conductive metal 260; a layer made from a flexible metal 262; and an adhesive layer 264. The adhesive layers 252 and 264 of the embodiment are both made from indium tin oxide, whereas in another embodiment both the adhesive layers may be made from a different material, or one adhesive layer may be of indium tin oxide and the other one may be of a different material. This is because the adhesive layers have only to harmonize physical properties between the base material 24 and main a portion of the metal layer and to enhance the adhesion therebetween.

All of the made-from-flexible-metal layers 254, 258, and 262 are made from the same material in the embodiment, whereas in another embodiment the layers may be of different materials, or some of them may be of the same material. The made-from-flexible-metal layers 254, 258, and 262 of the embodiment are made from indium.

While the made-from-well-conductive-metal layers 256, 260 of the embodiment are made from the same material, in another embodiment both of them may be made from another material, or one of them may be made from a different material. The made-from-well-conductive-metal layers 256, 260 of the embodiment are made from a copper.

In this embodiment the made-from-flexible-metal layer 254 is arranged adjacent to the adhesive layer 252. It is preferable in consideration of the influence resulting from the strain the base material that the made-from-flexible-metal layer 254 is arranged and then the layer the made-from-well-conductive-metal layer 256 is arranged in this way. In addition, because the made-from-well-conductive-metal layer 256 is further sandwiched using the made-from-flexible-metal layer 258, it is possible to cope with the strain of the base material 24 more flexibly. The adjoining made-from-well-conductive-metal layer 260 makes it possible to secure a higher conductivity in comparison to the case where it wouldn't be there. Moreover, the adjoining layer is sandwiched using the made-from-flexible-metal layer 262, which makes possible not only to cope with the strain of the base material 24 more flexibly but also to cope with a possible strain in another base material located beyond the adhesive layer 264 flexibly. Thus, the structure in which a made-from-well-conductive-metal layer is sandwiched with made-from-flexible-metal layers can be considered to be a preferable form.

While the multilayered metal layer of the embodiment is formed by depositing adhesive layers, flexible layers, and well-conductive layers on the base material 24 used as a substrate by sputtering, it may be formed by other methods. In this embodiment: the thickness of the base material 24 is 50-70 μm; the thickness of the adhesive layer 252 is approximately 500 angstroms; the thickness of the flexible layer 254 is approximately 5000 angstroms; the thickness of the well-conductive layer 256 is approximately 5000 angstroms; the thickness of the flexible layer 258 is approximately 5000 angstroms; the thickness of the well-conductive layer 260 is approximately 5000 angstroms; the thickness of the flexible layer 262 is approximately 5000 angstroms; and the thickness of the adhesive layer 264 is approximately 500 angstroms. The thicknesses are appropriately selected according to the condition where the block is used, etc., in which the thicknesses of the adhesive layers are preferably approximately 50-2000 angstroms and more preferably approximately 100-1000 angstroms. Further, the thicknesses of the flexible layers are approximately 500-20000 angstroms and more preferably approximately 1000-10000 angstroms. The thicknesses of the well-conductive layers are approximately 500-20000 angstroms and more preferably approximately 1000-10000 angstroms.

In this embodiment, conductive layers of the metal layer, which have been described as being composed of adhesive layers and conductive layers, are configured of three flexible layers and two well-conductive layers. However, it can be considered that increasing the number of the layers allows the block to withstand a larger strain and therefore the number of the layers should be selected appropriately based on the usage conditions, etc. Incidentally, because an excessively large number of the layers will complicate the manufacturing process, an excessively large number of layers are not necessarily preferable. (In another embodiment, indium-tin alloy was used for a similar structure.)

FIG. 4 shows the A-A cross section, i.e. a cut area, shown in FIG. 1. In this embodiment, vulcanized conductive and unvulcanized, non-conductive sheet members are used. As is clear from the drawings, the base materials 24, 28, 32, making electroconductive paths with respective metal layers 25, 29, 31, are protrudent from the sheet surface, and they are protruding relative to the non-conductive members 22, 26, 30, 34, and therefore their contact reliability is high. The reason why the sheet surface took such geometry is that rubber shrinks during a process of vulcanization by heating. In the process, the conductive elastomer is one that has been vulcanized, and the non-conductive elastomer is one that hasn't been vulcanized. Unvulcanized, non-conductive elastomer can be glued to a vulcanized elastomer by heating, etc. Therefore, the manufacturing method to be described below needs necessarily the addition of a coupling agent as an option and the step of adding the coupling agent can be eliminated from the process.

The anisotropically conductive block of the embodiment isn't particularly limited in its dimensions (length, width, and height). However, in the case where the block is used in a circuit board or the like, it is preferred that the block has dimensions adjusted to the size of the circuit. In such case, the dimensions are typically 0.3-2 cm×0.3-2 cm×0.3-2 cm.

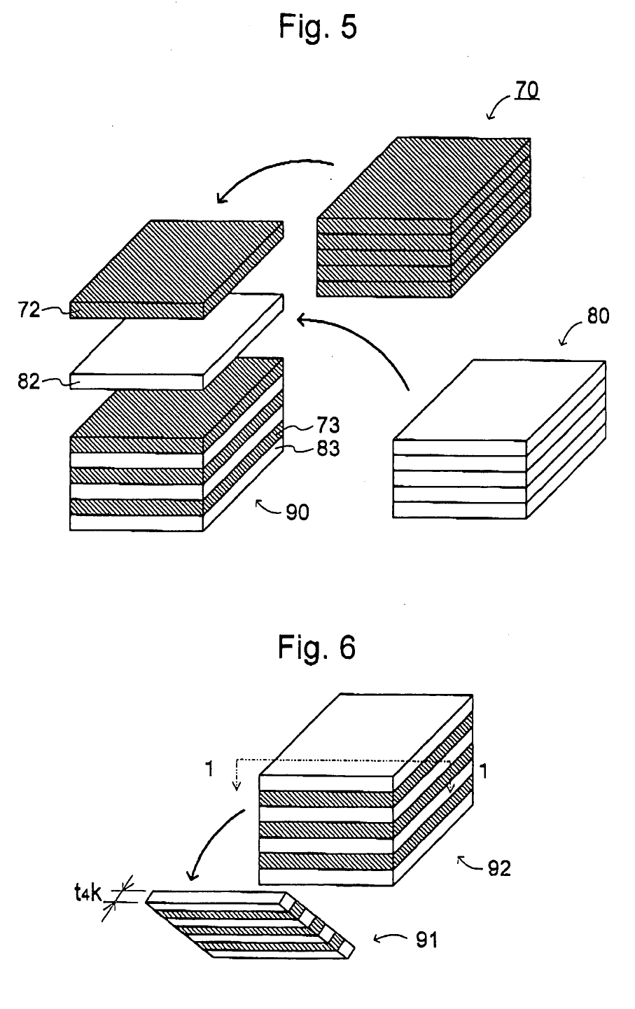

Referring to FIGS. 5-7, a method of manufacturing the anisotropically conductive block of the above embodiment will be described. FIG. 5 shows the way that an A-and-B-sheets-laminated structure (C) is formed by alternately stacking already-prepared conductive sheets (A) 70 and non-conductive sheets (B) 80 so that the upside surface (front surface) of each sheet contacts the downside surface (back surface) of another sheet. All the lowermost of the A-and-B-sheets-laminated structure (C) 90 in the course of stacking, a non-conductive sheet (B) 82 is further stacked and then a conductive sheet (A) 72 is stacked thereon. A coupling agent is put between the sheets thereby to bond each sheet to another. On the A-and-B-sheets-laminated structure (C) 90 in the course of stacking, the non-conductive sheet (B) 83 is arranged; the thickness of the sheet may be regarded as corresponding to the width of the non-conductive sheet 22 in FIG. 1, and the thickness of the conductive sheet 73 located thereon may be regarded as corresponding to the width of the electroconductive path 24 in FIG. 1. Thus, the width of the conductive m embers or n on-conductive m embers may be changed freely by changing the thickness of the sheets to be stacked and fine pitches that highly-integrated circuits, etc. demand can be achieved. Typically, those thicknesses are approximately 80 μm or less and the fine pitches are preferably approximately 50 μm or less. In this embodiment, the thicknesses of the non-conductive sheets (B) are approximately 30 μm and those of the conductive sheets are approximately 50 μm.

Now, the step of alternately stacking conductive and non-conductive sheets may include continuously stacking two or more conductive sheets and then stacking one or more non-conductive sheets. Likewise, the alternately stacking step may include continuously stacking two or more non-conductive sheets and then stacking one or more conductive sheets.

FIG. 6 shows the process of cutting the A-and-B-sheets-laminated structure (C) 92 formed by the above-described A and B sheets' stacking step. The A-and-B-sheets-laminated structure (C) 92 is cut along a cutting-plane line 1-1 so that the thickness of the resultant zebra sheet 91 is desired t₄ₖ (k: a natural number). The thickness t₄ₖ corresponds to the thicknesses of the zebra sheet 60, 62, 64, 66, and 68 in FIG. 1.

Thus, the zebra sheets of FIG. 1 can be controlled freely in their thicknesses and they may be the same or different in the thicknesses. The thicknesses are typically approximately 80 μm or less, preferably approximately 50 μm or less. Incidentally, the thicknesses are approximately 50 μm in this embodiment.

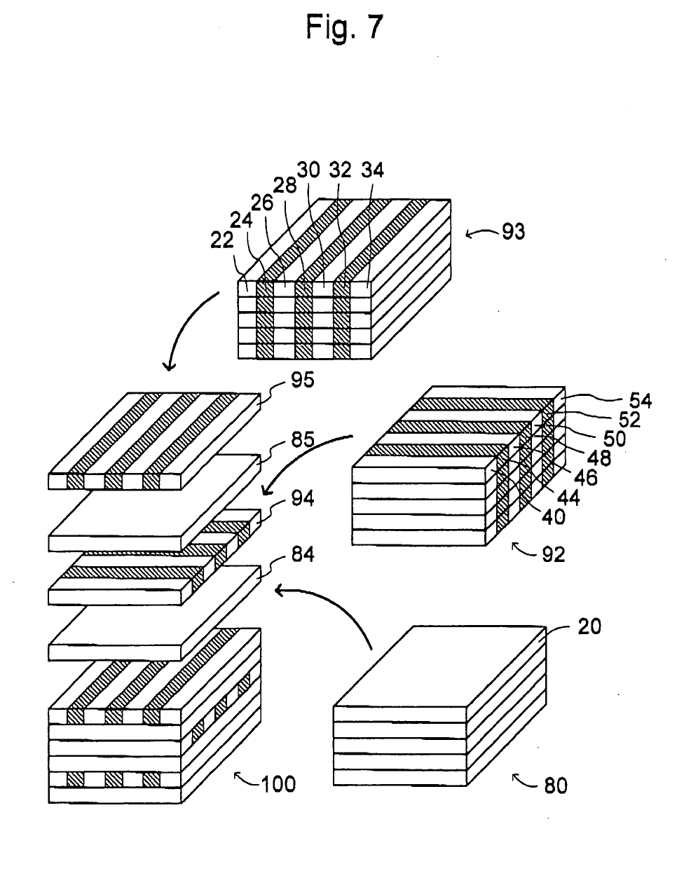

FIG. 7 shows the way that an anisotropically conductive block is formed by alternately stacking the zebra sheets 93 formed by the above-described process and non-conductive sheets (D) 80 so that the upside surface (front surface) of each sheet contacts the downside surface (back surface) of another sheet to be superposed thereon. Here, the zebra sheets 93 may be prepared in the condition where they are turned 90° for each sheet in their stacking order, or a stock of zebra sheets 93 already turned 90° may be prepared as shown in the drawing thereby to prepare two kinds of stocks of zebra sheets 93 for stacking and use the two stocks alternately. Further, it is shown the way that the non-conductive sheet (D) 84 is stacked on the zebra-and-D-sheets-laminated structure (E) 100 in the course of stacking, the zebra sheet 94 is stacked thereon, the non-conductive sheet (D) 85 is further stacked thereon, and then 90°-turned zebra sheet 95 is stacked thereon. A coupling agent is put between the sheet members thereby to bond each member to another. The anisotropically conductive block is thus formed.

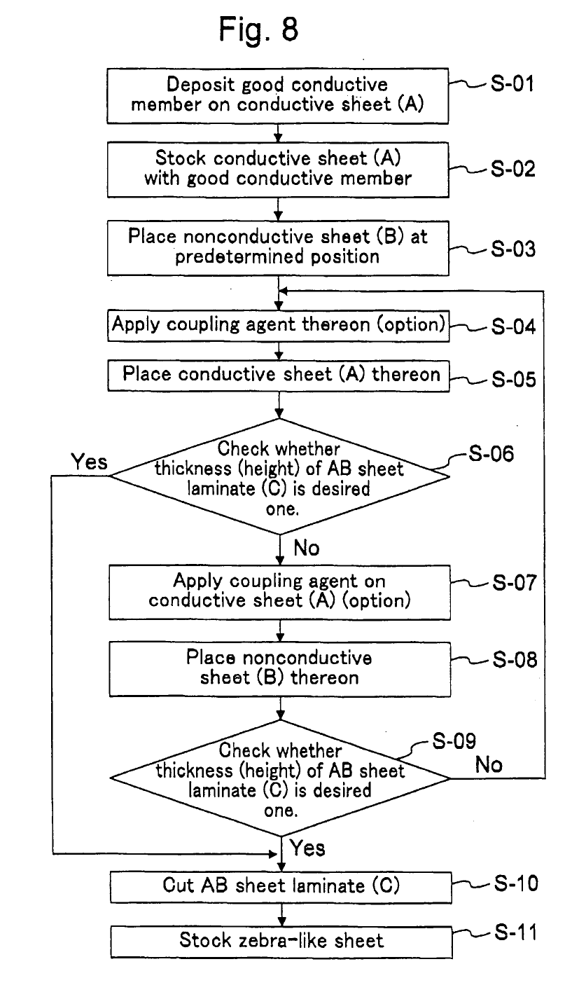

In FIG. 8, the method of manufacturing the above-described anisotropically conductive block is shown by a flow chart. If a well-conductive member is deposited to a conductive sheet (A), the well-conductive member is deposited on a surface of the conductive sheet (A) (S-01). For example, a metal layer may be formed as the well-conductive member on the surface of the conductive sheet (A) by sputtering. After the well-conductive member is thus deposited, the conductive sheet (A) with the well-conductive member is to be stocked for use in the next step (S-02). While there are some conductive sheets with no well-conductive member in the embodiment of FIG. 1, when an anisotropically conductive block containing such conductive sheets of the embodiment of FIG. 1 is to be formed, the process will start from the following step at least partially. A non-conductive sheet (B) is placed in a given position for stacking (S-03). Optionally, a coupling agent is put on the non-conductive sheet (B) (S-04). A conductive sheet (A) is placed thereon (S-05), provided that the conductive sheet (A) is a conductive sheet (A) with a well-conductive member if the step S-01 has been carried out and the same is hereinafter effective. The thickness (or height) of the A-and-B-sheets-laminated structure (C) resulting from the stacking is checked on whether it coincides with a desired thickness (or height) (S-06). If the thickness reaches a desired (predetermined) one, then go to the first cutting step of the A-and-B-sheets-laminated structure (C) (S-10). If thickness doesn't reach a desired (predetermined) one, then optionally put the coupling agent on the conductive sheet (A) (S-07). A non-conductive sheet (B) is placed thereon (S-08). The thickness (or height) of the A-and-B-sheets-laminated structure (C) resulting from the stacking is checked on whether it coincides with a desired thickness (or height) (S-09). If the thickness reaches a desired (predetermined) one, then go to the first cutting step of the A-and-B-sheets-laminated structure (C) (S-10). If thickness doesn't reach a desired (predetermined) one, then return to the step S-04 and optionally put the coupling agent on the conductive sheet (A) (S-04). In the first cutting step (S-10) the zebra sheets are cut from the A-and-B-sheets-laminated structure one by one or in groups of two or more, and stocked (S-11).

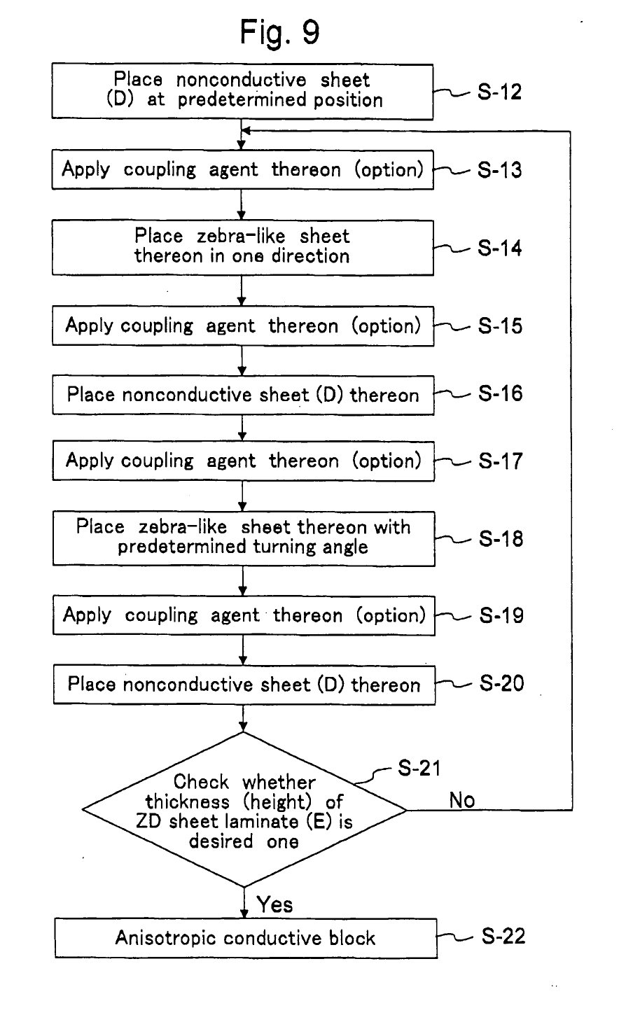

FIG. 9 shows a flow for forming an anisotropically conductive block from the zebra sheets and non-conductive sheets (D). First, one non-conductive sheet (D) is placed in a given position for stacking (S-12). Optionally, the coupling agent is put on the non-conductive sheet (D) (S-13). One zebra sheet is directed toward Direction 1 and placed thereon (S-14). Optionally, the coupling agent is put on the zebra sheet (S-15). Another non-conductive sheet (D) is placed thereon (S-16). Optionally, the coupling agent is put thereon (S-17). Another zebra sheet is turned by a predetermined angle (90° in the embodiment of FIG. 1) relative to Direction 1 and placed thereon (S-18). Optionally, the coupling agent is put thereon (S-19). Another non-conductive sheet (D) is placed thereon (S-20). The thickness (or height) of the zebra-and-D-sheets-laminated structure (E) resulting from the stacking is checked on whether it coincides with a desired thickness (or height) (S-21). If it reaches a desired (predetermined) one, then the zebra-and-D-sheets-laminated structure (E) is the intended anisotropically conductive block. If it doesn't reach a desired (predetermined) one, then return to the step S-13. Here, the step S-14 and the step S-18 can be replaced with each other, and the predetermined angle in S-18 may be an arbitrary angle or may be changed successively.

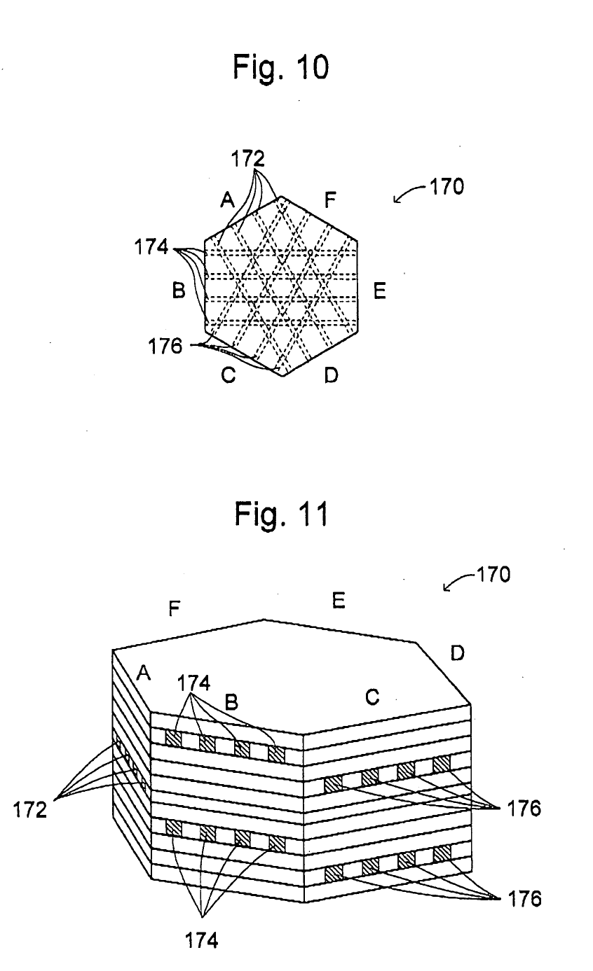

FIGS. 10 and 11 show a plain view and a sketch of an anisotropically conductive block of another embodiment. When the coordinate system of FIG. 2 is used, FIG. 10 corresponds to an illustration viewed from Z-axis direction. The anisotropically conductive block has the form of a hexagonal prism and stands along Z-axis direction. The side surfaces of the hexagonal prism are named A, B, C, D, E, and F, and there are conductivities independently in three directions of A-D, B-E, and C-F. Dotted lines in the drawing represent conductive paths, from which it is clear that the paths cross the hexagonal prism in the above-described three directions. The conductive path 172 for the A-D direction, the conductive path 174 for the B-E direction, and the conductive path 176 for the C-F direction are electrically connecting between respective paired side surfaces. While the conductive paths seem that they are intersecting each other in the plan view, the conductive paths in the three directions are never put in a so-called cross-wired condition and independent of each other because non-conductive sheets are actually interposed therebetween in Z-axis direction to insulate the paths as is clear from FIG. 11. Anisotropically conductive blocks like this can make three-directional connections readily.

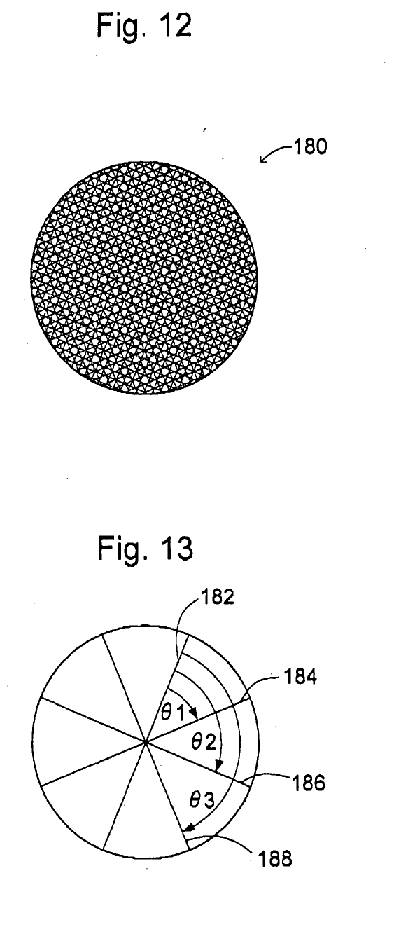

In FIGS. 12 and 13, there are plan views showing a cylindrical anisotropically conductive block of another embodiment. FIG. 12 is also an illustration viewed from Z-axis like FIG. 10, wherein conductive paths are shown with thin lines. While the conductive paths seem to intersect each other in FIG. 12, they are dislocated in Z-axis direction as in the above embodiment and therefore make mutually independent conductive paths. FIG. 13 is a view for detailed description of directions of the conductive paths, wherein there are shown: a first conductive-path direction 182; a second conductive-path direction 84 deviated by θ₁ from there; a third conductive-path direction 86 deviated by θ₂ from the first conductive-path direction 182; and a fourth conductive-path direction 88 deviated by θ₃ from the first conductive-path direction 182. In FIG. 13, conductive paths in parallel with the directions cross the cylinder in their respective layers thereby to electrically connect opposed side surfaces of the cylinder. The angles θ₁, θ₂, and θ₃ can be changed freely.

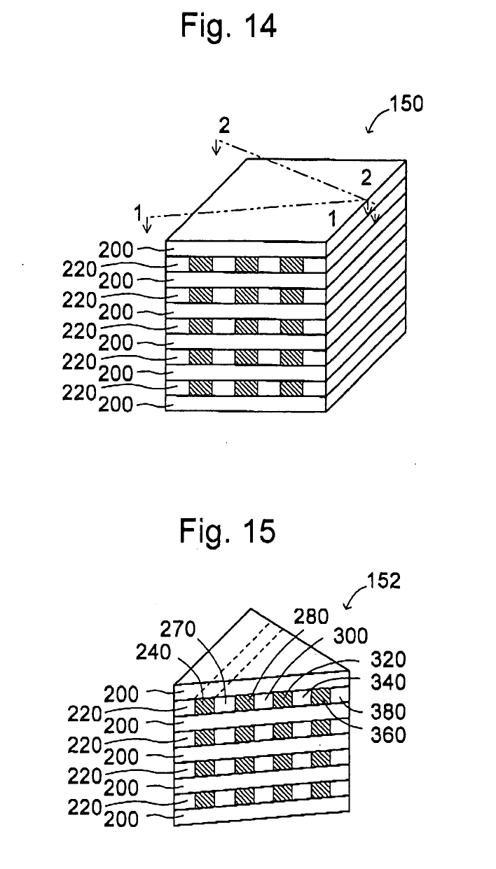

FIG. 14 is a sketch of an anisotropically conductive block 150 intended for only one direction. While non-conductive sheets 200 and zebra sheets 220 are alternately stacked, all of the conductive paths are of only one direction from a side surface on the near side in the drawing to another side surface on the far side. The anisotropically conductive block 52 cut along the cutting-plane lines 1-1 and 2-2 in FIG. 14 is shown in FIG. 15. The respective conductive paths 240, 280, 320, and 360 are in parallel with each other and electrically insulated by non-conductive members 270, 300, and 340.

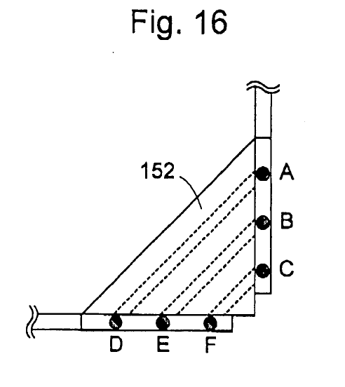

In the drawing, the state of the conductive path 240 inside the block is drawn with dotted lines. Such anisotropically conductive block 52 is capable of securing conductivity not between opposed side surfaces but between side surfaces with a certain angle formed therebetween. The situation where the anisotropically conductive block is applied to the corner terminals A, B, C, D, E, and F is shown in FIG. 16. Electrical continuity is established between A and D, B and E, and C and F. In other words, it can be used as an anisotropically conductive block for connecting electrical terminals located in a corner.

While the predetermined angles are approximately 45° in this embodiment, they may be a combination of approximately 30° and approximately 60°. This condition corresponds to an asymmetric case where combinations of terminals to be connected are A-E and B-F, for example. Further, when the connection between A and F is performed, the combined angles are an angle of less than 30° and an angle of more than 60°. Incidentally, the reason why such combination of angles is cited is that the connection between terminals is intended for terminals in faces, which are at least conditional to crossing at a substantially right angle when the faces are extended. In regard to the connection between faces with a more acute angle therebetween, the sum of the combined angles exceeds 90°; in regard to the connection between faces with a more obtuse angle therebetween (the angle is on the side of the supplementary angle with respect to the acute angle side), the sum of the combined angles is smaller than 90°. In other words, if the angle between two faces (on the side that electrical continuity is established) is expressed by θ₄, the sum of the combined angles is [180-θ₄].

As described above, the anisotropically conductive block of the present invention can impart electrical continuity between terminals in faces that are not substantially in parallel, such as faces intersecting at a substantially right angle. In addition, the block can impart electrical continuity between terminals in a pair of faces facing each other substantially in parallel and besides, it can impart electrical continuity between terminals in another pair of faces facing each other substantially in parallel. Therefore, the anisotropically conductive block can prevent circuit contact at nodes of electric circuits and connect the respective electric circuits.

1. An anisotropically conductive block having predetermined three dimensions, comprising:
a plurality of electroconductive paths inside said anisotropically conductive block;
a first conductive path being composed of at least one of said plurality of electroconductive paths between a first electrical contact point in electrical contact with a first region in an outer surface of said anisotropically conductive block and a second electrical contact point in contact with a second region of said outer surface; and
a second conductive path composed of at least one of said plurality of electroconductive paths between a third electrical contact point in electrical contact with a third region of the outer surface of said anisotropically conductive block and a fourth electrical contact point in contact with a fourth region of said outer surface,
wherein said first conductive path and said second conductive path are non-conductive with each other,
wherein a first direction of conductivity produced by linearly connecting said first electrical contact point with said second electrical contact point crosses a second direction of conductivity produced by linearly connecting said third electrical contact point with fourth electrical contact point at a predetermined angle.

2. An anisotropically conductive block having predetermined dimensions in X-axis, Y-axis, and Z-axis directions, each orthogonal to the others in three dimensions, the block having a conductive property evaluated between a first contact point in contact with a first region of an outer surface of the anisotropically conductive block and a second contact point in contact with a second region thereof,
wherein the conductive property is non-conductive when a line-connecting direction produced by connecting said first contact point with said second contact point is substantially in parallel with said Z-axis direction, and is conductive when said line-connecting direction is substantially in parallel with each of a predetermined first direction and a predetermined second direction, which are substantially in parallel with a plane defined by said X-axis and Y-axis,
wherein said first direction and second direction intersects in plan view as seen from said Z-axis, and
wherein said first direction and said second direction interfere with each other in conductivity.

3. An anisotropically conductive block being non-conductive in a first direction, comprising electroconductive paths therein independent in one or more different directions substantially perpendicular to said first direction,
wherein said electroconductive paths become usable by press-contacting with an outer surface of the anisotropically conductive block.

4. An anisotropically conductive block comprising electroconductive paths independent in a plurality of different directions,
wherein said plurality of different directions are substantially in parallel with one plane,
wherein in plan view if projected onto the one plane, at least one pair of directions selected from said plurality of different directions intersect in the one plane in plan view,
wherein in lateral view if projected onto a plane substantially perpendicular to the one plane, none of said plurality of different directions intersect, and
wherein said electroconductive paths become usable by press-contacting with the anisotropically conductive block.

5. The anisotropically conductive block according to claim 1, wherein the block is composed of: a conductive elastomer; and a non-conductive elastomer.

6. An anisotropically conductive block including a composite sheet comprising:
a non-conductive sheet of non-conductive material, having a substantially-constant thickness, and having an upside surface (front surface) and a downside surface (back surface) respectively on up and down sides across the thickness; and
a sheet having a substantially-constant thickness, having an upside surface (front surface) and a downside surface (back surface) respectively on up and down sides across the thickness, and having an electroconductive path extending from one end portion of the sheet to the other in a first direction substantially in parallel with the upside surface (front surface) or downside surface (back surface) of the sheet, the sheet with electroconductive path being superposed on the upside surface (front surface) of the non-conductive sheet so that the downside surface thereof is in contact with the upside surface (front surface) of said non-conductive sheet.

7. The anisotropically conductive block according to claim 6, wherein said non-conductive sheet comprises a non-conductive elastomer.

8. The anisotropically conductive block according to claim 1, wherein said electroconductive path comprises an electroconductive elastomer.

9. The anisotropically conductive block according to claim 8, wherein the electroconductive elastomer constituting the electroconductive path comprises a member of superior conductivity being in contact electrically along the path.

10. The anisotropically conductive block according to claim 9, wherein said member of superior conductivity comprises an adhesive layer and a conductive layer.

11. The anisotropically conductive block according to claim 10, wherein said adhesive layer comprises indium tin oxide.

12. The anisotropically conductive block according to claim 10, wherein said conductive layer comprises: a layer of good conductive metal; and a layer of flexible metal.

13. The anisotropically conductive block according to claim 1, wherein said electroconductive path is surrounded by non-conductive members along the path, and runs across the anisotropically conductive block, and
wherein an end portion of said electroconductive path appears in an outer surface of the anisotropically conductive block, and the end portion protrudes in comparison with non-conductive members around the appearing end portion.

14. A method of manufacturing an anisotropically conductive block, comprising:
an AB sheet stacking step of alternately stacking conductive sheets (A) of conductive material having a predetermined thickness and predetermined faces on up and down sides across the thickness and non-conductive sheets (B) of non-conductive material having a predetermined thickness and predetermined faces on up and down sides across the thickness thereby to produce an AB sheet laminate;
a cutting step of cutting said AB sheet laminate produced in the AB sheet stacking step into a zebra-like sheet in a predetermined thickness; and
a zebra-D sheet stacking step of alternately stacking zebra-like sheets produced in the cutting step and non-conductive sheets (D) of non-conductive material.

15. A method of manufacturing an anisotropically conductive block comprising:
a conductive material depositing step of depositing a good conductive member, which is a member of superior conductivity, on a surface of each of conductive sheets (A) of conductive material having a predetermined thickness and predetermined faces on up and down sides across the thickness thereby to produce conductive sheets (A) with good conductive member;
an AB sheet stacking step of alternately stacking said conductive sheets (A) with good conductive member produced in the conductive material depositing step and non-conductive sheets (B) of non-conductive material having a predetermined thickness and predetermined faces on up and down sides across the thickness thereby to produce an AB sheet laminate;
a cutting step of cutting said AB sheet laminate produced in the AB sheet stacking step into a zebra-like sheet with a predetermined thickness; and
a zebra-D sheet stacking step of alternately stacking said zebra-like sheets produced in the cutting step and non-conductive sheets (D) of non-conductive material.
